(19) United States
(12) Patent Application Publication
(10) Pub. No.: US 2019/0271264 A1
(43) Pub. Date: Sep. 5, 2019

(54) REDUCED DIESEL FUEL CONSUMPTION USING MONATOMIC OXYGEN

(71) Applicant: Combustion 8 Technologies LLC, Butler, WI (US)

(72) Inventors: Larry Daniel Nichols, Arlington, MA (US); Richard Eckhardt, Arlington, MA (US); Jim Scot Cowart, Annapolis, MD (US); David B. Cope, Medfield, MA (US); Daniel Kapustin, Delafield, WI (US)

(21) Appl. No.: 16/147,030

(22) Filed: Sep. 28, 2018

Related U.S. Application Data
(63) Continuation of application No. 14/899,396, filed on Dec. 17, 2015, now abandoned.
(60) Provisional application No. 61/836,575, filed on Jun. 18, 2013.

(51) Int. Cl. F02B 43/04; F02D 41/00; F02M 27/06; F02M 25/00; F02M 37/00; F02M 43/00; F02M 63/02

(52) U.S. Cl. CPC F02B 43/04; F02D 41/0025; F02M 27/06; F02M 25/00; F02M 2700/00; F02M 43/00; F02M 63/0225; F02M 2200/95; Y02T 10/32; F02M 37/0047

(57) ABSTRACT

One approach to providing atomic oxygen for the purpose of promoting more rapid and compact combustion is to disperse a low concentration of an atomic oxygen precursor, such as nitrous oxide (N₂O), into the compressed air in the cylinder before or close to the time of ignition. The introduction of N₂O may take place in the intake manifold, directly into the combustion chamber through a small orifice in the base of the fuel injector or a small nozzle located elsewhere in the cylinder head, or the N₂O can be added as a solute to the injected fuel.

### CROSS-REFERENCE TO RELATED APPLICATIONS

This application claims benefit of U.S. Provisional Application No. 61/836,575 filed on Jun. 18, 2013, the entire content of which is incorporated herein by reference.

### TECHNICAL FIELD

This disclosure relates to methods and apparatus for increasing diesel engine efficiency, specifically by reducing heat loss to cylinder walls by using a source of monatomic oxygen to produce more compact combustion and allow a partially insulating region to exist between the combustion zone and the walls.

### BACKGROUND

Diesel engines power many automobiles and commercial trucks in the United States, as well as many stationary generators. Their efficient operation is a matter of great importance economically, environmentally, and in terms of fossil fuel conservation.

A diesel engine is a type of internal combustion engine (ICE) in which a hydrocarbon fuel is injected directly into hot compressed air near the top of the compression stroke. The fuel immediately begins to vaporize and, in due course, to undergo spontaneous ignition and combustion. Gas heated to high temperatures and high pressures by the combustion of the fuel exerts a force on the piston, thereby converting the heat of combustion into useful mechanical work which can be delivered through the crankshaft to an external load.

FIGS. 1A-D illustrate the sequence of strokes—intake (FIG. 1A), compression (FIG. 1B), power (FIG. 1C), and exhaust (FIG. 1D)—by which a four-cycle diesel ICE 100 operates. During the intake stroke, shown in FIG. 1A, air (indicated by arrow 122) is drawn into the cylinder 115 as the intake valve opens 130 and the piston 120 descends (indicated by arrow 124). During the following compression stroke, shown in FIG. 1B, both the intake valve 130 and an exhaust valve 140 are closed and the rising piston 120 (indicated by arrow 126) compresses the air, increasing its pressure and temperature. Liquid hydrocarbon fuel 150 is then injected under high pressure directly into the hot compressed air near top dead center (TDC). The injected fuel 150 begins to vaporize upon injection and in due course to burn. The resulting release of heat energy causes a large additional increase in temperature and pressure, which forces the piston 120 downward (indicated by arrow 128) during the power stroke, as illustrated in FIG. 1C. Finally, the exhaust valve 140 opens as shown in FIG. 1D, venting and expelling the cylinder contents during the exhaust stroke (indicated by arrow 132) in preparation for the intake stroke of the next cycle.

In general, diesel fuel is less volatile than the gasoline used in spark ignition engines because it is intended for vaporization at much higher temperatures. It contains normal and branched alkanes as well as cycloparaffins and aromatic hydrocarbons. As compared to gasoline, diesel fuel generally contains a larger fraction of straight chain hydrocarbons which readily auto-ignite. Auto-ignition is necessary in a diesel engine, but can lead to knocking in a spark-ignition engine operating at a high load. Diesel engines are designed to operate with a large excess of air, and for that reason may burn more than 99% of the injected fuel, leading to low levels of unburned hydrocarbon emissions.

For the typical combustion temperatures attainable in conventional diesel engines, the Second Law of Thermodynamics does not allow more than about 65% of the heat of combustion to be converted into useful work. The actual efficiency is further reduced by in-cylinder heat losses to the cooling system, enthalpy wasted as heat, pressure and kinetic energy in the exhaust, and mechanical friction. As a result most vehicular diesel engines convert only 30% to 40% of the heat of combustion into useful mechanical work.

For the reasons set forth above, methods and systems that allow utilization of a larger fraction of the available energy in diesel fuel would provide an economically valuable increase in power and mileage, as well as associated environmental and resource conservation benefits.

### SUMMARY

Various aspects of the invention are summarized as follows.

In general, in an aspect, a method includes providing monatomic oxygen in a combustion chamber in a diesel engine sufficiently prior to or at the time of ignition of diesel fuel in the combustion chamber at a time relative to the time of ignition and in an amount sufficient so that combustion of the diesel fuel in the combustion chamber adjacent a wall of the combustion chamber is reduced.

Implementations of this aspect may include one or more of the following features:

In some implementations, the presence of the monatomic oxygen can result in a layer of gas that at least partially insulates the wall of the combustion chamber. The partially insulating layer can reduce heat transfer from the combustion chamber to the wall of the combustion chamber.

In some implementations, a fuel efficiency of the diesel engine can be improved by the monatomic oxygen. In some cases, the fuel efficiency can be improved by at least about 2%, at least about 5%, at least about 10%, at least about 15%, or at least about 20%. In some cases, the fuel efficiency can be improved by up to about 30%, up to about 35%, or up to about 40%.

In some implementations, the monatomic oxygen can reduce a duration of combustion of the diesel fuel.

In some implementations, the monatomic oxygen can reduce a size of a combustion zone of the diesel fuel.

In some implementations, the monatomic oxygen can reduce an amount of heat transferred to the wall of the combustion chamber during combustion of the diesel fuel.

In some implementations, providing the monatomic oxygen can include introducing nitrous oxide (N₂O) into the combustion chamber. In some cases, the N₂O can be introduced at a rate in the range from 0.001% to about 10% of the rate of fuel consumption. In some cases, the N₂O can be introduced at a concentration relative to the diesel fuel in a range from 0.1% to about 2% by weight, in a range from 0.3% to 1.8% by weight, or in a range from 1.0% to 1.6% by weight. In some cases, the N₂O can be introduced into the combustion chamber via an intake manifold airstream. In some cases, the N₂O can be introduced into the combustion chamber through an orifice in the combustion chamber. In some cases, the N₂O can be introduced into the combustion chamber as a series of pulses. In some cases, introducing the N₂O includes sensing one or more parameters associated with the diesel engine and modifying one or more parameters associated with introducing the N₂O. In some cases, the one or more parameters associated with the diesel engine can be selected from the group consisting of a vehicle speed and an engine load. In some cases, the one or more parameters associated with introducing the N₂O can be selected from the group that includes an amount of N₂O, a frequency of the pulses, and a timing of the pulses with respect to the ignition of the diesel fuel. In some cases, the N₂O can be introduced as a solute in the injected diesel fuel. In some cases, diesel fuel can be delivered to the combustion chamber via a low pressure pump and then via a high pressure pump. In some cases, the N₂O can be delivered to the diesel fuel from a pressurized container via a metering valve or positive displacement pump located between the low pressure pump and the high pressure pump. In some cases, a flow of N₂O and a timing of fuel injection can be controlled based on one or more parameters associated with the diesel engine. In some cases, one or more parameters associated with the diesel engine can be selected from the group that includes a vehicle speed and an engine load. In some cases, the engine includes a common rail configured to deliver the diesel fuel and N₂O to the combustion chamber. In some cases, the engine further includes one or more high-pressure solenoid pumps operated by an electronic control unit, and delivery of the diesel fuel and N₂O to the combustion chamber includes using the solenoid pumps to pulses of N₂O to fuel lines leading from the common rail to the combustion chamber.

In some implementations, the monatomic oxygen can be provided by introducing ultraviolet light in the combustion chamber. In some cases, the ultraviolet light can be introduced within about 10 ms of the time of ignition of the diesel fuel, within about 5 ms of the time of ignition of the diesel fuel, within about 2 ms of the time of ignition of the diesel fuel, or within about 1 ms of the time of ignition of the diesel fuel. In some cases, the ultraviolet light can be introduced by an electric arc discharge. In some cases, energy for the electric arc can be stored in one or more capacitors and delivered to electrodes inside the combustion chamber. In some cases, the arc discharge can dissipate at least 1 joule of energy. In some cases, the ultraviolet light can be produced by a flash lamp. In some cases, the flash lamp can be a xenon flash lamp. In some cases, the ultraviolet light can be introduced via a window or optical coupling. In some cases, the window or optical coupling includes a material that is transparent to light having a wavelength of 180 nm to 220 nm. In some cases, the window or optical coupling includes fused silica and/or sapphire. In some cases, the introduction of the ultraviolet light can be timed based on a signal from a crankshaft angle detector. In some cases, the ultraviolet light can be produced by an electrical discharge in the air within the combustion chamber. In some cases, energy for the electric arc can be stored in one or more capacitors and delivered to electrodes inside the combustion chamber. In some cases, a voltage pulse can be delivered to an electrode inside the combustion chamber sufficient to trigger a discharge of the energy from the one or more capacitors. In some cases, the electrical discharge can be timed based on a signal from a crankshaft angle detector.

In general, in another aspect, a diesel engine includes a means for providing monatomic oxygen in a combustion chamber in the diesel engine sufficiently prior to or at the time of ignition of diesel fuel in the combustion chamber and in an amount sufficient so that combustion of the diesel fuel in the combustion chamber adjacent a wall of the combustion chamber is reduced.

Implementations of this aspect may include one or more of the following features:

In some implementations, the diesel engine can further include an electronic control module in communication with the means and configured to control the timing of providing the monatomic oxygen in the combustion chamber.

In some implementations, the electronic control module can cause the monatomic oxygen to be present in the combustion chamber within about 10 ms of the time of ignition of the diesel fuel, within about 5 ms of the time of ignition of the diesel fuel, within about 2 ms of the time of ignition of the diesel fuel, or within about 1 ms of the time of ignition of the diesel fuel.

In some implementations, the means includes a means for introducing nitrous oxide (N₂O) into the combustion chamber. In some cases, the means for introducing N₂O can be configured to introduce the N₂O at a rate in the range from 0.001% to about 10% of the rate of fuel consumption. In some cases, the means includes means for introducing N₂O into an intake manifold airstream of the diesel engine. In some cases, the means can include means for introducing N₂O pulses through an orifice directly into the combustion chamber. In some cases, the means can include an electronic control module including an electronic processor, stored instructions, and one or more electronic sensors arranged to monitor one or more parameters of the diesel engine, the electronic control module being configured to regulate delivery of N₂O to the combustion chamber and the injection of diesel fuel to the combustion chamber based on the one or more monitored parameters.

In some cases, the means can be configured to introduce N₂O as a solute in the diesel fuel. In some cases, the diesel engine can include a low pressure pump and a high pressure pump for delivering diesel fuel to the combustion chamber, where the means delivers the N₂O to the diesel fuel through a metering valve or positive displacement pump while the diesel fuel is between the low pressure pump and the high pressure pump.

In some implementations, the means includes an electronic control module configured to control a flow of N₂O and a timing of fuel injection into the combustion chamber.

In some implementations, the diesel engine includes a common rail configured to deliver mixed N₂O and diesel fuel to the combustion chamber through one or more high-pressure solenoid pumps.

In some implementations, the diesel engine includes a means for delivering pulses of N₂O into one or more fuel lines leading from the common rail to the combustion chamber.

In some implementations, the means can include a source of ultraviolet light. In some cases, the ultraviolet light source can include an arc discharge source. In some cases, the arc discharge source can be configured to dissipate at least 1 joule of energy with each discharge. In some cases, the ultraviolet light source can be a flash lamp. In some cases, the flash lamp can be a xenon flash lamp. In some cases, the diesel engine includes a window or optical coupling arranged to deliver ultraviolet light from the ultraviolet light source to the combustion chamber. In some cases, the window or optical coupling can be formed from a material transparent to light having a wavelength of 180 nm or less. In some cases, the window or optical coupling can be formed from fused silica or sapphire. In some cases, the diesel engine can include a crankshaft angle detector arranged to detect an angle of a crankshaft associated with the combustion chamber, the arc discharge source being configured to provide the ultraviolet light based on a signal from crankshaft angle detector. In some cases, the arc discharge source can include electrodes positioned in the combustion chamber and one or more capacitors arranged to deliver energy to the electrodes. In some cases, the source of ultraviolet light can be an arc electrical discharge configured to produce a pulse of ultraviolet light in air within the combustion chamber. In some cases, the diesel engine can include one or more capacitors configured to deliver energy to the electrodes. In some cases, the diesel engine can include a crankshaft angle detector arranged to detect an angle of a crankshaft associated with the combustion chamber, the arc discharge source being configured to provide the ultraviolet light based on a signal from crankshaft angle detector.

In general, in another aspect, a diesel engine includes one or more combustion chambers, a diesel fuel delivery system arranged to deliver diesel fuel from a fuel tank to the one or more combustion chambers, a light source module arranged to provide ultraviolet radiation to at least one of the combustion chambers, and an electronic control module in communication with the diesel fuel delivery system and the light source module and programmed to coordinate delivery of diesel fuel to the combustion chambers and delivery of ultraviolet radiation to provide monatomic oxygen in the combustion chamber at a time of combustion of diesel fuel in the combustion chamber.

Implementations of this aspect may include one or more of the following features:

In some implementations, the light source module can include a lamp. In some cases, the lamp can be a flash lamp. In some cases, the flash lamp can be a Xenon flash lamp.

In some implementations, the light source module can include electrodes, at least part of which are located within the combustion chamber. In some cases, the light source module can further include electronic components arranged to apply a potential to the electrodes sufficient to cause an electric arc discharge between the electrodes sufficient to introduce the ultraviolet light in the combustion chamber.

In some cases, the electronic control module can be programmed so that the ultraviolet radiation is delivered to the combustion chamber within 2 ms of ignition of diesel fuel in the combustion chamber.

In general, in another aspect, a diesel engine includes one or more combustion chambers, a diesel fuel delivery system arranged to deliver diesel fuel from a fuel tank to the one or more combustion chambers, a monatomic oxygen precursor delivery module arranged to provide monatomic oxygen to at least one of the combustion chambers, and an electronic control module in communication with the diesel fuel delivery system and the monatomic oxygen precursor delivery module and programmed to coordinate delivery of diesel fuel to the combustion chambers and delivery of a monatomic oxygen precursor from the monatomic oxygen precursor delivery module to provide monatomic oxygen in the combustion chamber at a time of combustion of diesel fuel in the combustion chamber.

Implementations of this aspect may include one or more of the following features:

In some implementations, the monatomic oxygen delivery module can include a tank of N₂O.

In some implementations, the monatomic oxygen precursor delivery module can be arranged to provide monatomic oxygen to at least one of the combustion chambers by delivering a monatomic oxygen precursor to the combustion chamber. In some cases, the monatomic oxygen precursor delivery module can be arranged to deliver the monatomic oxygen precursor to the combustion chamber by supplying the monatomic oxygen precursor to the diesel fuel prior to the diesel fuel being delivered to the combustion chamber. In some cases, the monatomic oxygen precursor delivery module can be arranged to deliver the monatomic oxygen precursor to the combustion chamber by supplying the monatomic oxygen precursor to the combustion chamber separate from delivery of the diesel fuel to the combustion chamber.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A-D show the sequence of strokes of an example diesel internal combustion engine.

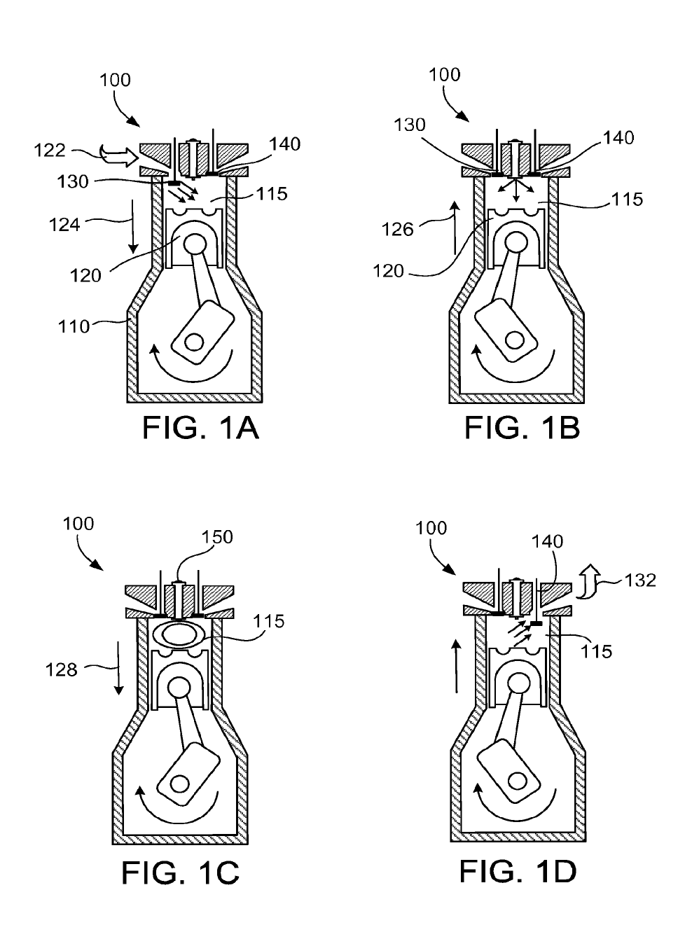

FIG. 2 shows an example diesel engine fuel delivery system equipped for addition of N₂O to the fuel.

FIG. 3 shows an example diesel engine fuel delivery system modified for addition of nitrous oxide to the fuel.

FIG. 4 shows an example nitrous oxide delivery system in which liquid N₂O is delivered directly to a fuel line on its way from a common rail to a fuel injector.

FIG. 5 shows an example UV light injection assembly for supplying a pulse of UV-rich light to the interior of an diesel engine combustion chamber.

FIG. 6 shows the top of one cylinder of an internal combustion engine installed with the UV light injection assembly of FIG. 5.

FIG. 7 shows an example electric arc flash unit for creating an intense flash of light.

FIG. 8 shows an example electronic circuit used to create an electric arc.

FIG. 9 shows an example configuration for testing the performance of an engine with a nitrous oxide delivery system.

### DETAILED DESCRIPTION

Other than mechanical friction, factors limiting the efficiency of diesel engines are generally tied to the conditions prevailing during the in-cylinder combustion. In particular, it is believed that causing the air-fuel mixture to burn more rapidly and completely before reaching the cylinder walls may allow a less heated layer to persist near the walls, reducing heat loss to the walls and thereby improving engine efficiency. It is further believed that causing the air-fuel mixture to burn more rapidly and completely may provide more time for the combustion gases to expand against the piston, thereby delivering more mechanical work and lowering the heat and pressure lost when the exhaust is vented.

One factor controlling both the duration of combustion and the size of the zone in which combustion takes place is the nature of the oxidizing species encountered by the fuel. Normally the only such species is molecular oxygen, O₂, which for quantum mechanical reasons is believed to react relatively slowly with fuel molecules. It is believed that monatomic oxygen atoms is capable of reacting more rapidly than molecular oxygen, but engine temperatures are not generally high enough to dissociate O₂ into significant amounts of free O. Thus auto-ignition of diesel fuel during compression relies on a gradual increase in local temperature caused by relatively slow reactions involving molecular oxygen, such as

R—H+O═O→R+H—O—O.,

R—H+H—O—O→R+H—O—O—H

H—O—O—H→2 HO.,

R—H+HO.→R+H₂O,

R.+O═O→R—O—O., etc.

These reactions continue until they produce temperatures and free radical concentrations high enough to initiate the avalanche of combustion-propagating chain reactions. At that point, ignition has occurred and full combustion can begin.

While normal combustion in diesel engines is controlled, for example, by engine operating conditions and the kinetics of slow reactions involving fuel and O₂ molecules, the situation would be far different if free O atoms were present, because such atoms can react vigorously with fuel molecules to cause rapid ignition. Because heat alone does not produce enough free O atoms, it is believed that diesel combustion can be improved by introducing free O atoms from some other source, at a time and place where they will do the most good.

Accordingly, methods are disclosed which can be used to introduce a small but effective concentration of atomic oxygen into the combustion chamber at a time and location suited to promote rapid and compact combustion at a greater distance from the cooled metal walls of the combustion chamber. In other words, the methods may reduce a duration of combustion in a cylinder relative to the duration combustion would otherwise take in the absence of the atomic oxygen. Furthermore, combustion may be confined to a zone that is smaller than the volume of the combustion chamber (e.g., 99% or less of the volume of the combustion chamber, 95% or less of the volume of the combustion chamber, 90% or less of the volume of the combustion chamber). Both the duration of combustion and the size of the combustion zone may be measured by visual observation (e.g., by use of a high speed camera) or other means.

In situations where the zone of combustion is reduced in volume relative to the size of the combustion zone without atomic oxygen and the combustion zone does not extend to the walls of the chamber, it is believe that the air between the combustion zone and the walls thus constitutes a partially insulating layer which can hinder heat loss to the walls and leave more energy available to do mechanical work. In some implementations, the increased speed of combustion may require a delay in fuel injection to ensure that the combustion peak pressure is still reached at the most effective time, for example a few crankshaft degrees after TDC (e.g., 10° or less, 8° or less, 5° or less, 4° or less, 3° or less, 2° or less, 1° or less).

One approach to providing atomic oxygen for the purpose of promoting more rapid and compact combustion is to disperse a low concentration of an atomic oxygen precursor, such as nitrous oxide (N₂O), into the compressed air in the cylinder before or close to the time of ignition. The introduction of N₂O may take place in the intake manifold, directly into the combustion chamber through a small orifice in the base of the fuel injector or a small nozzle located elsewhere in the cylinder head, or the N₂O can be added as a solute to the injected fuel.

Introduction of N₂O directly into the combustion chamber may be done continuously, or it may be pulsed so as to occur at the time of, or shortly before, auto-ignition. Introduction of N₂O as a solute in the fuel may be done in the low pressure fuel line leading to the engine, into the high pressure fuel line leading to the injectors, or inside the injectors themselves.

Introduction of N₂O into the fuel immediately before injection may eliminate the need to store, handle, or dispense quantities of N₂O-loaded fuel which could emit N₂O vapor into the atmosphere, where it acts as a greenhouse gas, or into the head space of tanks and storage vessels, where it could pose a safety risk. Instead, the N₂O would be provided in pressurized containers prefilled with the compound in liquid form, ready to be attached to a coupling in the engine compartment. Tanks of liquefied N₂O are classified as safe for public sale and U.S. interstate transport. It is believed that liquid N₂O does not cause explosions, and it is believed that the compound is completely destroyed by diesel combustion, so the disclosed approach may fully address safety and pollution concerns.

Without wishing to be bound by theory, it is believed that when heated, nitrous oxide dissociates to produce nitrogen and atomic oxygen:

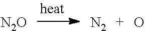

This heat-catalyzed reaction begins near the time and place of auto-ignition, specifically in the sheath of combustion which originates along the surface of the jet of vaporizing fuel where vaporized fuel mixes with atmospheric oxygen. Thereafter the thermally initiated release of monatomic oxygen from N₂O follows the expanding flame front, assisting in flame propagation and leading to more rapid and compact combustion which is separated from the cooled walls of the combustion chamber by a partially insulating region of flame-free air.

It has been found that as little as 1.25 wt-% of nitrous oxide for example, based on the rate of fuel consumption, can lead to a reduction in fuel consumption in excess of 25%.

Implementations of this technique are not to be confused with the practice of introducing a pound or more per minute of N₂O into racing engines to produce a large but necessarily brief increase in engine power. Such power enhancement is attributable to two factors:
1. N₂O contains 36% oxygen, compared with 21% in air, so when N₂O is used to replace a large fraction of the incoming air the engine can burn more fuel and produce more power.
2. N₂O is a refrigerant which, when stored as a pressurized liquid and then released into the inlet airstream, causes a drop in temperature. This increases the density of the intake gas and provides even more oxygen.

This practice relies on very rapid consumption of N₂O, typically pounds per minute, to produce a very large increase in power, typically tens of horsepower. In contrast, implementations of the techniques disclosed here rely on a comparatively low consumption rate of N₂O, typically grams per minute (e.g., 20 g/min or less, 10 g/min or less, 5 g/min or less, 3 g/min or less, 2 g/min or less, 1 g/min or less), to produce an economically attractive reduction in fuel consumption of 25% or more. It is believed that the two schemes differ in their method, their purpose, and their underlying mechanisms.

Introduction of monatomic oxygen into the combustion chamber may be achieved using other means. For example, in some implementations, an intense burst of short wavelength UV light is projected through a UV-transparent window directly into the combustion chamber of a diesel engine at the time of, or shortly before the time of auto-ignition. Such irradiation can produce sufficient free O atoms to promote more rapid and compact combustion, away from the combustion chamber walls, to reduce the rate of heat loss, improve engine efficiency, and reduce fuel consumption.

The dissociation energy of an O₂ molecule corresponds to a photon wavelength of 242 nm, which is in the ultraviolet (UV) portion of the electromagnetic spectrum. Radiation at shorter wavelengths is strongly absorbed by O₂, with copious production of free O atoms. Ambient air, which is 21% oxygen, interacts with such UV so strongly that it can travel only a short distance before being absorbed.

The degree of absorption of UV light by O₂ increases rapidly at wavelengths shorter than 242 nm. In order to produce a burst of monatomic O atoms throughout a significant volume near the top of the compression stroke, the UV radiation should be largely absorbed while traveling a distance between 0.5 and 5.0 cm, which will allow it to deposit most of its energy over a significant volume before reaching the walls. In compressed air that path length corresponds to wavelengths just below 220 nm, so UV with a wavelength of about 180 to 220 nm can be taken as representative of radiation suitable for dissociating O₂ into O atoms throughout a significant volume of a combustion chamber.

In general, a variety of UV light sources may be used. An exemplary light source is a short-arc xenon discharge lamp. In a short-arc xenon discharge lamp, a brief high current arc is struck between two closely spaced metal electrodes in a xenon atmosphere. The result is a powerful burst of visible and ultraviolet radiation comprised of characteristic xenon emission lines superimposed on a background of black-body radiation. Such a lamp, for example, the Excelitas model 4402 (commercially available from Excelitas Technologies Corp., Waltham, Mass.), can be operated at power levels as high as 60 watts while flashing 60 times a second and delivering up to 100 mJ of total optical energy per flash. As much as 2 mJ of that radiation can be at wavelengths below 220 nm. That proves to be sufficient to dissociate enough O₂ molecules to promote more rapid and compact combustion out of contact with the walls, thereby diminishing heat loss and reducing fuel consumption by over 25%.

To make effective use of the optical output of a xenon flash lamp, optics (e.g., lenses, mirrors, etc.) can be used to efficiently direct light from the lamp to the combustion chamber. Such optics can be fabricated from a material highly transparent in the 180 nm to 220 nm range and thermally and mechanically strong enough to survive prolonged exposure to combustion conditions. Commercially-available synthetic fused silica and sapphire are examples of such materials. Such UV-transparent optical components should not become occluded by combustion products, because enough UV, visible, and infrared energy will be absorbed by any deposit to vaporize or displace it.

Other techniques for generating monatomic oxygen are also possible. For example, certain implementations involve striking a high-current electric arc directly in the compressed air inside the combustion chamber rather than in an enclosed lamp external to the combustion chamber. In such implementations, the electrodes that create the electrical arc are not enclosed, and therefore produce UV and other radiation which illuminates the entire combustion chamber, generating monatomic oxygen and promoting flame propagation over a large volume.

A high current electrical arc in air is known to produce a significant amount of UV light. For example, workers using arc welding equipment must wear protective clothing to prevent skin or eye damage from the intense UV light created by the welding arc through air. In fact, at high current density, air is nearly as efficient at generating UV light as a xenon arc lamp. Because of the xenon line spectrum, xenon arc lamps produce some UV light efficiently when operated at low current density, but when operated at high current density the UV light output is primarily the result of the very high temperature gas acting as a black body radiator.

In some implementations the electric arc may be positioned so as to illuminate the entire combustion chamber, and timed to produce a flash of intense UV light 0 to 0.1 msec before fuel injection (e.g., within 0.05 msec, within 0.03 msec, within 0.01 msec, within 0.005 msec, within 0.001 msec of fuel injection), thus making a widespread distribution of monatomic oxygen available during the period leading up to auto-ignition. In some implementations the arc may be positioned near the point of fuel injection and fired near the time of injection, so as to produce a high concentration of monatomic oxygen in the immediate temporal and spatial vicinity of the vaporizing fuel.

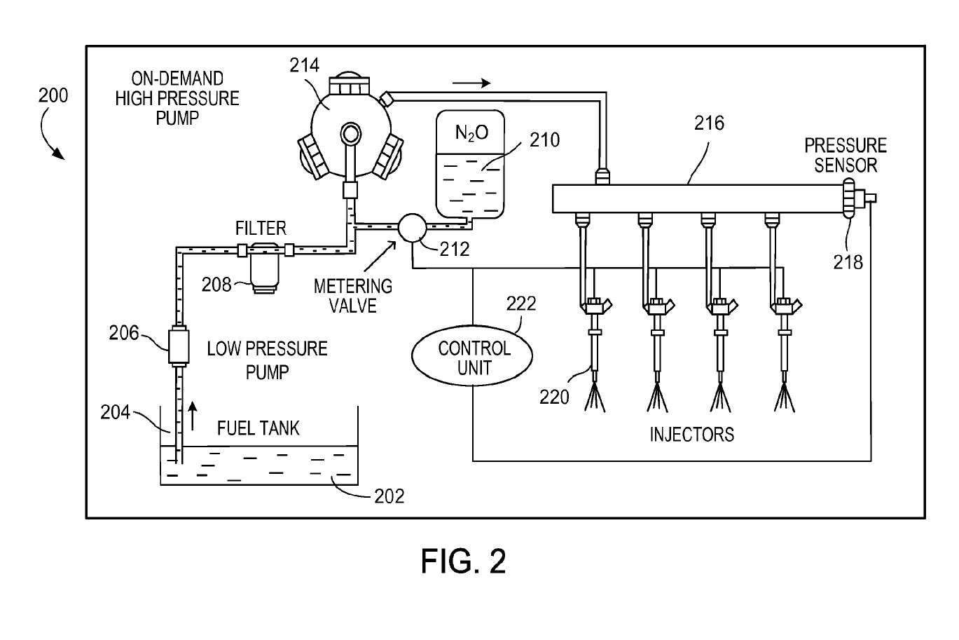

FIG. 2 shows a schematic drawing of a diesel engine fuel delivery system 200 equipped for addition of N₂O to the fuel. Fuel from tank 202 passes through an outlet tube 204 to a low pressure pump 206 which delivers it through a fuel filter 208. Simultaneously, liquid N₂O from a pressurized tank 210 passes through a metering valve 212 where it merges with fuel before passing through a high, constant pressure, on-demand pump 214. The N₂O-loaded fuel then enters high pressure manifold 216, called a common rail, where its pressure is monitored by a sensor 218 before it enters individual injectors 220 which spray it, with proper timing (for example within a crankshaft angle of ±10° from top dead center, such as within ±8°, within ±5°, within ±4°, within ±3°, within ±2°, within ±1°) into the combustion zone of each cylinder. The desired fuel injection timing can be adjusted and controlled by an electronic engine control unit 222 similar to those commonly installed on conventional vehicular diesel engines. In some implementations, the fuel may be fed individually to each injector, or the injectors may be timed by cams, but such designs allow the use of N₂O injection in much the same way as the common rail system shown in FIG. 2.

The metering valve 212 is under the control of an electronic system which adjusts the flow of N₂O to maintain a desired concentration in the fuel. In some implementations, the N₂O may pass through its own high pressure pump before being introduced into the high pressure fuel immediately before the fuel injectors 220, and the electronic control system may or may not include a processor coded to vary the N₂O concentration in response changes in engine RPM and the air-to-fuel ratio.

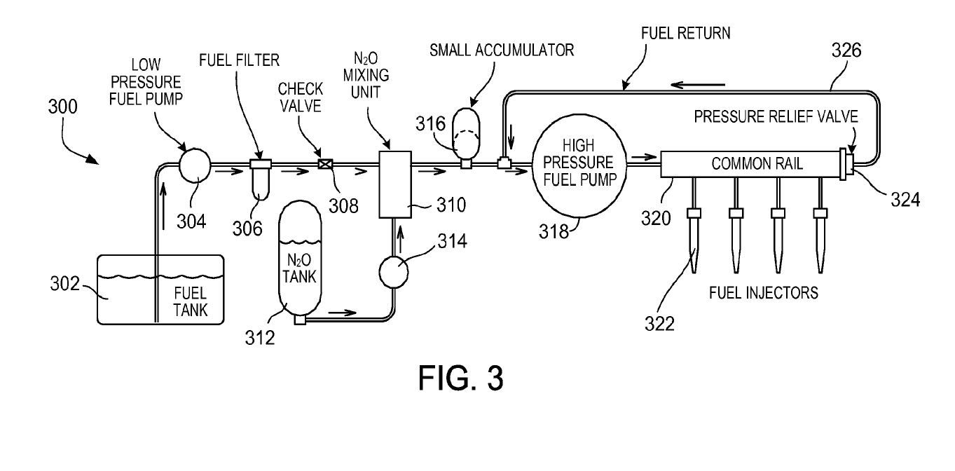

FIG. 3 shows a schematic of another implementation of a diesel engine fuel delivery system 300 modified for addition of nitrous oxide to the fuel using an accumulator vessel to obviate the need for an on-demand constant pressure high pressure pump. Referring to FIG. 3, fuel is drawn from a fuel tank 302 by a low pressure pump 304 and delivered through a fuel filter 306 and check valve 308 to a mixing unit 310, which blends the fuel with a fixed proportion of liquid nitrous oxide from a pressurized tank 312 and N₂O metering valve 314. The N₂O-doped fuel then passes to an accumulator 316 which provides a feed stream to the high pressure pump 318, which in turn delivers N₂O-doped fuel at high pressure to the common rail 320 and from there to the individual injectors 322. Excess fuel from the common rail escapes through a pressure relief valve 324 and recirculates through a return fuel line 326 to the high pressure pump 318, so only the small volume of fuel actually consumed need be replaced by the low pressure pump 304 and the accumulator 316. Check valve 308 acts as a safety to prevent N₂O-doped fuel from ever returning to the fuel tank 302 to eliminate the possibility of N₂O gas accumulating in the fuel tank 302.

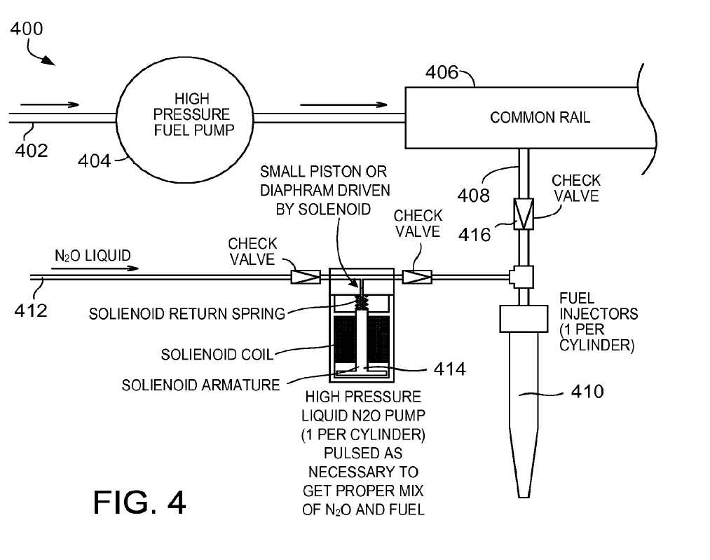

FIG. 4 shows another implementation of a nitrous oxide delivery system 400 in which liquid N₂O under autogenous pressure is delivered by a high pressure solenoid pump directly to each fuel line on its way from the common rail to a fuel injector. Referring to FIG. 4, fuel 402 from the fuel tank (not shown) is pressurized by a high pressure pump 404 and passed to a common rail 406 from which it passes through individual feed lines 408 to the fuel injectors 410. Concurrently, liquid N₂O 412 from a pressurized holding tank (not shown) passes into a small, calibrated volume, high pressure solenoid pump 414 whose pulses are adjusted to produce the desired concentration of N₂O. The pulse of high pressure nitrous oxide is then blended with the fuel en route to the fuel injector 410. Check valve 416 acts as a safety to prevent N₂O-doped fuel from ever returning to the fuel tank to eliminate the possibility of N₂O gas accumulating in the fuel tank.

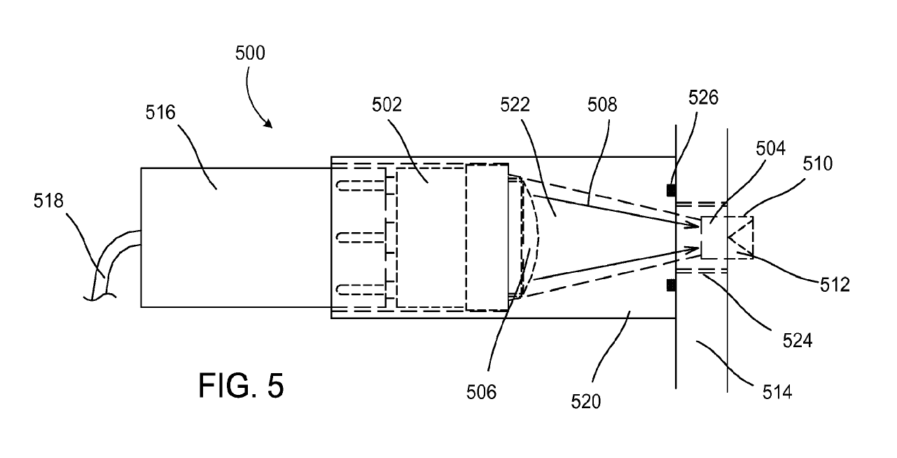

In some implementations, an ultraviolet flash lamp can be used to introduce an intense flash of light, rich in short wavelength UV radiation, through a window directly into the combustion chamber near or shortly before the time of fuel ignition. FIG. 5 shows an example implementation of a UV light injector assembly 500 for supplying a pulse of intense UV-rich light to the interior of a diesel engine combustion chamber from a source external to the chamber. In this example implementation, the light is produced by a short-arc xenon flash lamp 502, though other light sources can be used. This flash lamp 502 includes an integral reflector (e.g., a parabolic reflector) to collimate the majority of its light into parallel rays. For practical considerations in the construction of many internal combustion engines, the window 504 passing UV light into the cylinder should be relatively small, for example 2 mm to 10 mm in diameter, and preferably 4 mm to 8 mm in diameter. To direct the collimated rays of light from the flash lamp 502 through the window 504, a UV-transparent condensing lens 506 is used to focus the light 508 from the flash lamp 502 onto the window 504. For transparency to short wavelength UV, the condensing lens 506, window 504, and window extension 510 can be made of synthetic fused silica, sapphire, or another UV transparent material that has sufficient strength and heat resistance. Likewise, the flash lamp 502 envelope uses one of these UV transparent materials to allow the UV light to exit. An alternative construction is to use a flash lamp 502 with an ellipsoidal reflector which provides focused rather than collimated light, thus eliminating the need for the condensing lens 506.

FIG. 5 also shows an alternate window shape 510 that includes a protrusion 512 into the engine cylinder. This protrusion 512 has a concave depression in the end, such as a conical indentation, to provide a reflective surface or total internal reflection surface to distribute the light inside the cylinder for more effective illumination of the combustion volume. The window extension 510 may be asymmetrical, particularly if the window 504 is not centered in the top of the cylinder head 514. The shape of the extension 510 can be used to distribute the light in an optimum pattern within the engine cylinder.

In addition to the optical components, this example configuration includes an electrical connector and trigger module 516 for the flash lamp 502. This module 516 has one or more wires 518 that connect to a power source and a flash timing controller (not shown) that assures that the flash of light occurs with the desired intensity and at the desired time.

A mechanical housing 520 holds all the optical and electrical components in the proper position and contains a UV-transparent atmosphere 522 such as a near vacuum, nitrogen gas, or another gas that does not significantly absorb the short wavelength UV. The mechanical housing 520 includes a threaded protrusion 524 that holds the window 504 and screws into the engine cylinder head 514 to direct the light 508 into the cylinder. A pressure seal 526 is included around the threaded protrusion 524 to contain the high pressure gases in the engine cylinder. The mechanical housing 520 may be hexagonal in cross-section for easy screwing and tightening into the cylinder head 514. This mechanical configuration can be easily attached to or detached from the engine for installation, repair or replacement.

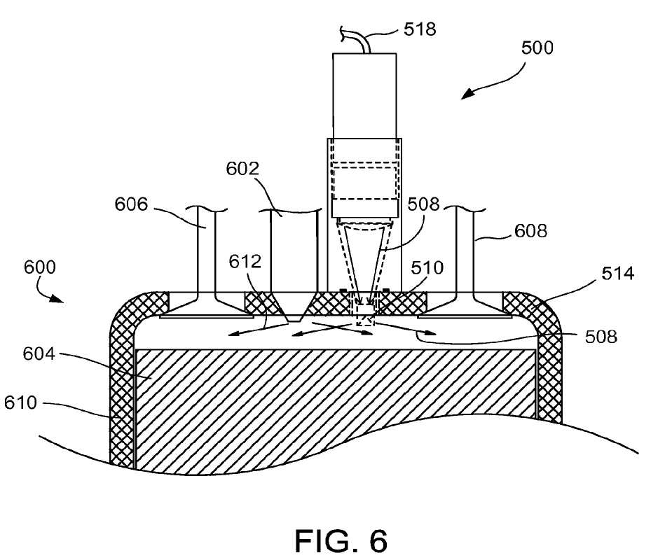

FIG. 6 shows a simplified diagram of the top of a cylinder 600 of an internal combustion engine with the UV light injector assembly 500 installed so that the light distributor extension 510 of the window protrudes through the engine cylinder head 514 into the combustion space at the top of the engine cylinder. The UV light injector assembly 500 is positioned near the fuel injector 602 so the UV light 508 can illuminate the volume into which the fuel is injected. The light distributor 510 can be shaped such that the light from the flash lamp is primarily directed to the desired volume where the combustion will be initialized.

One or more wires 518 connect the UV light injector assembly 500 to a power source and flash timing controller (not shown) that cause the flash of light to occur at the desired time. The timing of the electric arc flash unit can be determined by a crankshaft angle sensor and control module already provided on diesel vehicles to time fuel injection. This time will typically be when the piston 604 is near the top of the compression stroke, for example between a crankshaft angle of 5° to 0° before fuel injection. At this time both the intake valve 606 and the exhaust valve 608 are closed so the hot air contained within the volume created by the cylinder walls 610, piston 604, and cylinder head 514 is compressed and ready to support combustion. The fuel injector 602 injects a fuel spray 612 into the combustion volume when the air has been compressed to near its minimum volume. The UV light dissociates oxygen in the air into oxygen atoms and thereby reduce heat loss to the walls by promoting a rapid and compact combustion zone which makes minimal contact with the metal walls. The energy from the flash of light can also promote more rapid burning by assisting in the evaporation of the fuel droplets.

In some implementations, atomic oxygen within the combustion chamber is generated by using an electric arc exposed directly inside the combustion chamber to produce an intense flash of light containing short wave UV radiation. The arc electrodes can be positioned so that all the light emitted from the arc permeates the cylinder volume. This eliminates the costs and losses associated with the optics necessary to direct light from an external source into the cylinder.

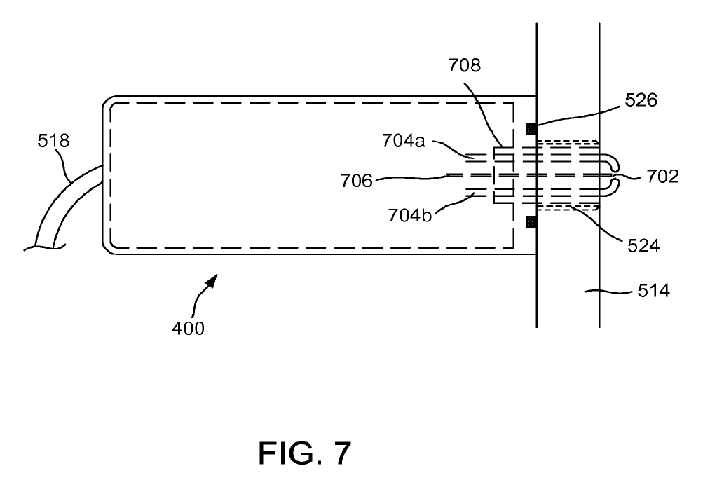

FIG. 7 shows an example configuration of an electric arc flash unit 700 useful for creating an intense flash of light, containing short wavelength UV radiation, directly inside a diesel engine combustion chamber. In this example configuration, the electric arc 702 is created between two arc electrodes 704a-b which extend through the cylinder head 514 into the internal volume of the engine cylinder. The arc electrodes 704a-b are connected to a source of electrical energy of sufficient voltage (typically 1,000 to 3,000V) to create a high energy electric arc 702 between the arc electrodes 704a-b. Because of the elevated air pressure in the cylinder, a third higher voltage trigger electrode 706 is used to initiate the arc 702 and control the precise timing.

The energy for the electric arc 702 is stored in one or more capacitors that are contained in the housing of the electric arc flash unit 700, or alternatively in a remote location dictated by available space or other considerations. Control wires 518 connect to the control electronics (not shown) to provide the energy to charge the capacitors, and to provide the trigger signal to initiate the electrical arc 702 at the desired time. If the energy storage capacitors are in a remote location, these wires 518 include the two conductors that connect directly to the arc electrodes 704a-b. In general, the control electronics can include standard and/or custom components, such as data storage media (e.g., a non-volatile memory chip) and an electronic processor (e.g., an ASIC).

The electric arc flash unit 700 includes a threaded protrusion 524 that is screwed into a hole in the cylinder head 514. The central portion of this protrusion is filled with a high temperature insulating material 708, such as a ceramic, to keep the electrodes (704a-b and 706) electrically isolated from each other and provide a gas-tight seal. A pressure seal 526 is also included around the threaded protrusion 524 to provide an additional seal against gas leakage.

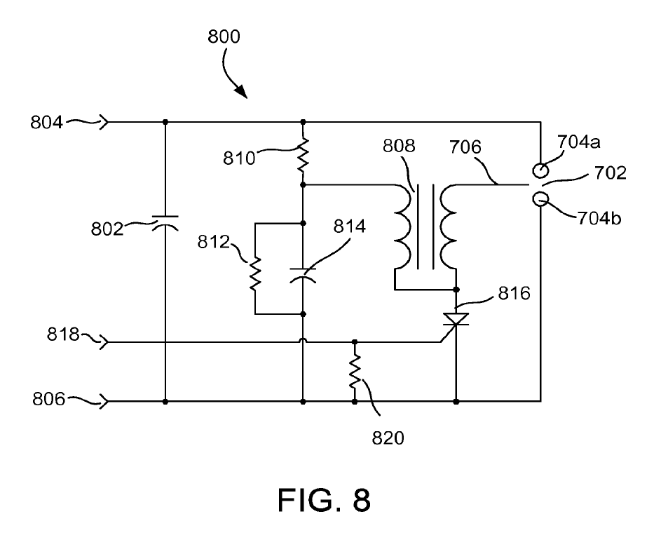

FIG. 8 shows a schematic diagram of an electronic circuit 800 that can be used to create the electric arc 702. The circuit 800 includes of one or more energy storage capacitors 802 that hold energy for rapid electrical current delivery to the arc electrodes 704a-b. To obtain the highest efficiency of UV light production the energy storage capacitors 802 should generally be charged to a voltage greater than 1,000V. If other system constraints require a lower voltage, useful results can be achieved with voltages as low as a few hundred volts. The energy storage capacitors 802 are charged from an external high voltage power supply (not shown) which applies the charging current 804 to the energy storage capacitors 802 with a ground return connection 806. The energy storage capacitors 802 are charged during the interval of time between successive electrical arcs.

The value of the energy storage capacitors 802 is chosen to provide the desired amount of energy to the flash. Flash energy will typically be in the range of 0.5 to 5 joules per flash depending on the size of the engine and other operating characteristics. The energy in the energy storage capacitors 802, in joules, is defined by the expression 0.5CV² where C is the total capacitor value in farads, and V is the voltage on the capacitor(s) in volts. For example, a 2 microfarad capacitor charged to 2 kV would store 4 joules of electrical energy. Because of the elevated air pressure in the cylinder, a higher voltage trigger electrode 706 may be needed to partially ionize the air between the arc electrodes 704a-b and initiate the electric arc 702 at the desired time. The trigger voltage is typically in the range from 5,000 to 50,000 volts. The trigger pulse can be very short, with a duration on the order of 1 microsecond. These pulses can be produced using a trigger transformer 808 designed for use with standard xenon flash lamps.

Standard flash trigger transformers 808 are typically designed to be powered from a voltage of approximately 200V to 300V, so this circuit includes a voltage divider made up of resistors 810 and 812 to provide the appropriate voltage from the higher voltage energy storage capacitors 802. An additional, much smaller trigger energy storage capacitor 814 holds energy for the trigger transformer 808 to produce the high voltage trigger pulse. The trigger pulse is produced when the flash trigger silicon-controlled rectifier (SRC) 816 is turned on with a flash trigger signal 818 from the control electronics (not shown). When the flash trigger SCR 816 is turned on, current flows from the trigger energy storage capacitor 814 through the flash trigger transformer 808 to electrical ground 806. The windings in the flash trigger transformer 808 have a high ratio (e.g., 20 to 100 as needed) between the secondary and primary to produce the high voltage trigger pulse to the trigger electrode 706. Resistor 820 is included to reduce the likelihood of triggers to the flash trigger SCR 816 due to spurious electrical noise on the flash trigger signal line 818.

In an example implementation, resistors 810, 812, and 820 are 1M ohm, 100K ohm, and 1K ohm resistors, respectively, trigger energy storage capacitor 814 is a 0.47 μF capacitor, trigger electrode 706 delivers a 25 KV pulse, and the voltage differential between arc electrodes 704a-b is 1 to 3 KV. These component parameters are given as an example. Components having different parameters may be used, depending on the implementation.

The components, steps, features, objects, benefits and advantages that have been disclosed above are merely illustrative. Neither they, nor the discussions relating to them, are intended to limit the scope of protection in any way. Numerous other embodiments can be envisioned, including embodiments that have fewer, additional, and/or different components, steps, features, objects, benefits and advantages. Nothing that has been stated or illustrated is intended to cause a dedication of any component, step, feature, object, benefit, advantage, or equivalent to the public. While particular embodiments of the present application have been described, variations of the present application can be devised without departing from the inventive concepts disclosed in the disclosure.

### EXAMPLES

Example implementations are described below.

Example 1. In one example, over the course of 15 minutes, 100 grams of nitrous oxide is bubbled through 3000 grams of CN 45 diesel fuel, causing a weight gain of 10 grams, equivalent to 0.33%. A similar quantity of unmodified fuel is reserved in an identical container, and both containers are weighed. A John Deere M4024T four cylinder diesel engine mounted on a test rack and governed at 1800 RPM is rigidly connected to a 60 cycle AC Dynamo which in turn is connected to a set of four individually switchable 5 kW electrical heaters. A control panel is provided to allow RPM, current and voltage to be read in real time. Fuel consumption is monitored by weight.

The engine is started on standard diesel fuel from its own tank and allowed to reach steady state operating conditions for 15 minutes under a 5 kW load. Fuel flow is then switched to the graduated container of unmodified fuel and the engine is operated with a 5 kW load for 5 minutes, at which time flow is switched to the N₂O doped fuel for the same length of time. At the beginning and end of these operating intervals the containers are weighed. Fuel flow is then switched back to fuel from the main tank, and the engine is allowed to equilibrate for 15 minutes with a 10 kW load. The same procedure is then followed with the two containers of unmodified and modified fuel, and this sequence is again followed with 15 kW and 20 kW loads. In all cases the actual load is determined by current and voltage readings.

Table 1 shows the results of these tests:

TABLE 1

| | | |
|---|---|---|
| | Unmodified Fuel | N₂0-Doped Fuel |
| Load | Consumption | Consumption |

| | | | | | |
|---|---|---|---|---|---|
| 0 | kW | 18 | gm/min | 14 | gm/min |
| 5 | kW | 30 | gm/min | 24 | gm/min |
| 10 | kW | 60 | gm/min | 49 | gm/min |
| 15 | kW | 90 | gm/min | 70 | gm/min |
| 20 | kW | 120 | gm/min | 98 | gm/min |

Over this range of loads, the consumption of fuel is reduced between 18% and 23% when the engine is operating on fuel containing 0.33% N₂O by weight.

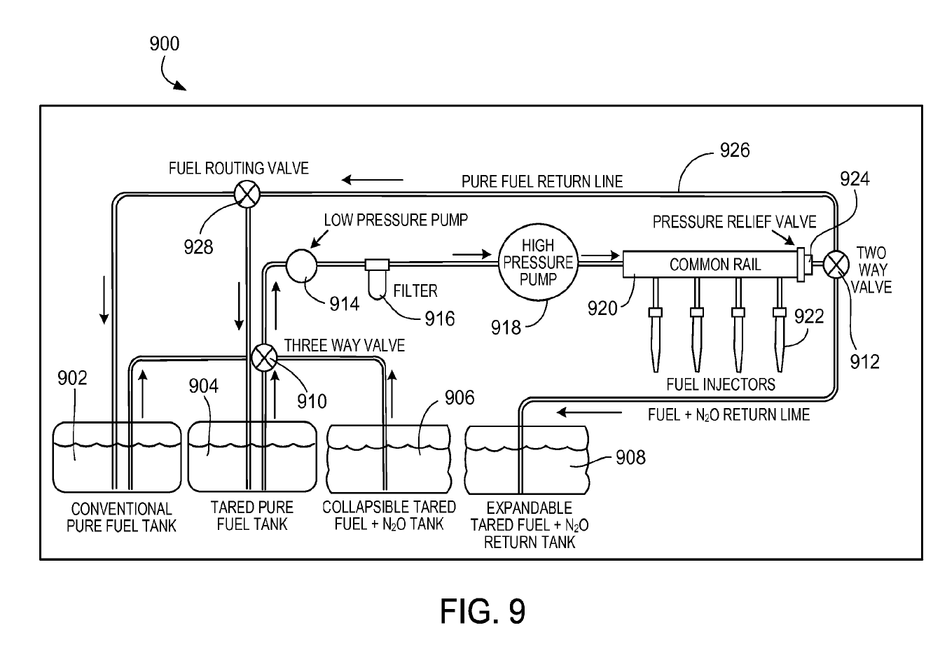

Example 2. In another example, a Ford F250 truck powered by a 6.0 liter V8 Power Stroke diesel is modified as shown schematically in FIG. 9.

An experiment is conducted as follows to determine the improvement in mileage of a diesel vehicle produced by a small concentration of N₂O in the fuel. Referring to system 902 of FIG. 9, at the beginning of the experiment, tank 902, the truck's original fuel tank, is filled with conventional fuel having a cetane number of 45; tank 904 is filled with 60.0 kg of the same fuel; and tank 906 is filled with 59.79 kg of the same fuel in which 0.21 kg of N₂O (0.35% by weight) has been dissolved in a manner similar to that of Example 1.

During travel to a test route, valves 910 and 912 are set so as to deliver fuel from tank 902 through the low pressure pump 914, the filter 916, and the high pressure pump 918 to the common rail 920, from which it is distributed to the individual injectors 922, with excess fuel escaping through pressure relief valve 924 and then flowing through two way valve 912, return line 926, and routing valve 928 back to fuel tank 902.

Upon the truck arriving at the starting site three way valve 910 is set so as to draw fuel from tank number 904, and two way valve 928 is set to return excess fuel back to tank 904. The truck is immediately driven on a round trip over the 50 km test course, adhering as closely as possible to a predetermined sequence of speeds not exceeding 80 km/hr.

When once again at the starting point, valve 910 is set so as to draw N₂O-containing fuel from tank 906, valves 912 and 928 are set so as to deliver excess fuel from the pressure relief valve 924 to waste tank 908, and the truck is driven on a round trip over the same course adhering as nearly as possible to the same sequence of speeds.

During this part of the test run, tanks 906 and 908 automatically adjust their volume so as to minimize head space over the N₂O-containing fuel, thus mitigating any slight risk of exothermic decomposition of N₂O vapor and allowing and little or no N₂O (a known greenhouse gas) to be released into the atmosphere.

At the conclusion of the experiment valves 910, 912 and 928 are returned to their initial settings so as to draw fuel from, and return fuel to, tank 902; after which the truck is driven back to its base of operations and the weight of fuel remaining in tanks 904, 906, and 908 is accurately determined.

The mileage obtained using the two fuels is then calculated based on the 100 km total length of the course and the weight of fuel consumed, (60 kg minus the weight of fuel in tank 904) for regular fuel and (60 kg minus the weight of fuel in tank 906 plus the weight of fuel in tank 908) for the N₂O-containing fuel. The results of three repetitions of this experiment show the average mileage on conventional fuel to be 17.1 mpg and the average mileage on N₂O-containing fuel to be 21.4 mpg. Thus under the conditions described here the improvement achieved by the addition of 0.35% N₂O to the fuel is 25.1%.

Example 3. In another example, a flash lamp and power assembly similar to that shown in FIG. 6 is mounted on each of the four cylinders of a John Deere M40241 diesel engine, and is provided with a timing circuit keyed to the crankshaft angle. The engine is operated at a governed speed of 1800 RPM while driving a 60 hertz AC generator connected to a variable load. When in use the UV flash lamps are triggered to produce monatomic oxygen by means of an arc delivering 1 joule of energy 2° of crankshaft angle before fuel injection.

The engine is allowed to equilibrate under each set of test conditions for 5 minutes and is then operated for an accurately timed 15 minute test period. Fuel consumption is obtained by weighing the fuel container before and after the test period.

Table 2 shows the total fuel consumed under different test conditions:

TABLE 2

| | | |
|---|---|---|
| External UV Source | Load | Fuel Consumed |

| | | | | |
|---|---|---|---|---|
| Off | 5 | kW | 450 | gm |
| On | 5 | kW | 360 | gm |
| Off | 10 | kW | 900 | gm |
| On | 10 | kW | 720 | gm |
| Off | 15 | kW | 1350 | gm |
| On | 15 | kW | 1080 | gm |
| Off | 20 | kW | 1800 | gm |
| On | 20 | kW | 1440 | gm |

As shown above, over this range of loads a consistent 20% reduction in fuel consumption is provided by a pulsed external UV source.

Example 4. In another example, the experiment of Example 3 was repeated with an electric arc flash unit similar to that shown schematically in FIG. 7 replacing the external flash lamp.

Table 3 shows the total fuel consumed under these various test conditions:

TABLE 3

| | | |
|---|---|---|
| Internal Arc UV Source | Load | Fuel Consumed |

| | | | | |
|---|---|---|---|---|
| Off | 5 | kW | 450 | gm |
| On | 5 | kW | 348 | gm |
| Off | 10 | kW | 900 | gm |
| On | 10 | kW | 696 | gm |
| Off | 15 | kW | 1350 | gm |
| On | 15 | kW | 996 | gm |
| Off | 20 | kW | 1800 | gm |
| On | 20 | kW | 1395 | gm |

As shown above, the reduction in fuel consumption achieved by internally generated short wavelength ultraviolet light ranges from 22% to 26%.

While several example implementations are described, these are merely examples to demonstrate various benefits of the disclosed systems and techniques. Other embodiments are in the following claims.

1. A method, comprising:
providing monatomic oxygen in a combustion chamber in a diesel engine sufficiently prior to or at the time of ignition of diesel fuel in the combustion chamber at a time relative to the time of ignition and in an amount sufficient so that combustion of the diesel fuel in the combustion chamber adjacent a wall of the combustion chamber is reduced.

2. The method of claim 1, wherein the presence of the monatomic oxygen results in a layer of gas that at least partially insulates the wall of the combustion chamber.

3. The method of claim 2, wherein the partially insulating layer reduces heat transfer from the combustion chamber to the wall of the combustion chamber.

4. The method of claim 1, wherein a fuel efficiency of the diesel engine is improved by the monatomic oxygen.

5. The method of claim 4, wherein the fuel efficiency is improved by at least about 2%.

6-12. (canceled)

13. The method of claim 1, wherein the monatomic oxygen reduces a duration of combustion of the diesel fuel.

14. The method of claim 1, wherein the monatomic oxygen reduces a size of a combustion zone of the diesel fuel.

15. The method of claim 1, wherein the monatomic oxygen reduces an amount of heat transferred to the wall of the combustion chamber during combustion of the diesel fuel.

16. The method of claim 1, wherein providing the monatomic oxygen comprises introducing nitrous oxide (N₂O) into the combustion chamber.

17. The method of claim 16, wherein the N₂O is introduced at a rate in the range from 0.001% to about 10% of the rate of fuel consumption.

18-20. (canceled)

21. The method of claim 16, wherein the N₂O is introduced into the combustion chamber via an intake manifold airstream.

22-23. (canceled)

24. The method of claim 16, wherein introducing the N₂O comprises sensing one or more parameters associated with the diesel engine and modifying one or more parameters associated with introducing the N₂O, wherein the one or more parameters associated with the diesel engine are selected from the group consisting of a vehicle speed, an engine load, an amount of N₂O, a frequency of the pulses, and a timing of the pulses with respect to the ignition of the diesel fuel.

25-26. (canceled)

27. The method of claim 16, wherein the N₂O is introduced as a solute in the injected diesel fuel.

28-33. (canceled)

34. The method of claim 1, wherein the monatomic oxygen is provided by introducing ultraviolet light in the combustion chamber.

35. The method of claim 34, wherein the ultraviolet light is introduced within about 10 ms of the time of ignition of the diesel fuel.

36-50. (canceled)

51. The method of claim 34, wherein the electrical discharge is timed based on a signal from a crankshaft angle detector.

52. A diesel engine, comprising:
a means for providing monatomic oxygen in a combustion chamber in the diesel engine sufficiently prior to or at the time of ignition of diesel fuel in the combustion chamber and in an amount sufficient so that combustion of the diesel fuel in the combustion chamber adjacent a wall of the combustion chamber is reduced.

53-80. (canceled)

81. A diesel engine, comprising:
one or more combustion chambers;
a diesel fuel delivery system arranged to deliver diesel fuel from a fuel tank to the one or more combustion chambers;
a light source module arranged to provide ultraviolet radiation to at least one of the combustion chambers; and
an electronic control module in communication with the diesel fuel delivery system and the light source module and programmed to coordinate delivery of diesel fuel to the combustion chambers and delivery of ultraviolet radiation to provide monatomic oxygen in the combustion chamber at a time of combustion of diesel fuel in the combustion chamber.

82-92. (canceled)
